(19) United States
(12) Patent Application Publication
(10) Pub. No.: US 2010/0180055 A1
(43) Pub. Date: Jul. 15, 2010

(54) MONITOR SHARING SYSTEM

(76) Inventors: Geoff M. Lyon, Menlo Park, CA (US); Jean Tourrilhes, Mountain View, CA (US); Craig Peter Sayers, Menlo Park, CA (US)

Correspondence Address: HEWLETT-PACKARD COMPANY;Intellectual Property Administration, 3404 E. Harmony Road, Mail Stop 35, FORT COLLINS, CO, 80528, US

(21) Appl. No.: 12/353,019

(22) Filed: Jan. 13, 2009

(51) Int. Cl. G06F 13/12; G06F 13/00

(52) U.S. Cl. 710/62; 710/316

(57) ABSTRACT

A display monitor includes a plurality of monitor inputs, a monitor switch for switching between the plurality of monitor inputs, a plurality of universal serial bus (USB) ports, where a first one of the USB ports is positioned at a first location and is dedicated to a first processing device, a second one of the USB ports is positioned at a second location and is dedicated to a second processing device, and a third one of the USB ports is positioned at a third location and is dedicated to either the first processing device or the second processing device. In addition, the display monitor includes a USB switch for switching between the plurality of USB ports to selectively activate the plurality of USB ports, where the monitor switch is internally linked to the USB switch to cause the monitor switch and the USB switch to switch concurrently with each other.

### BACKGROUND

Computer monitors or displays are typically large and expensive compared to other computer peripherals. Hence, in many instances (in business or home applications) computer monitors are shared between multiple computers, such as personal computers (PCs) or workstations, to save cost and desk space. This is especially true for the larger and more expensive monitors. For example, an office user may share a single display monitor between a desktop computer and laptop computer, or multiple office users may share multiple display monitors with multiple computers. Similarly, a home user or a college student in a dorm may share one monitor between a PC and a video component, such as a cable-box or a DVD player, whereby the display monitor may be used as both a television monitor and a computer display. Hence, as referred herein, a “display monitor” (or “monitor” for short) is any device that is operable to display video or images output from a computer or any other video component.

Conventionally, the dual use of or dual connection to a single monitor is made possible through the use of multiple inputs that are available on some monitors or the use of an external switching device, such as a KVM (Keyboard, Video, Mouse) switch. As is generally understood in the art, a KVM switch is a device that allows a console to be shared between multiple PCs. As the name KVM implies, the console includes a keyboard, a video display and a mouse. Certain KVM products also support sharing of analog audio signals and generic USB devices. A typical setup of a desktop KVM system 100 is illustrated in FIG. 1. As shown, a KVM switch 130 allows a monitor 110, a keyboard 140 and a mouse 150 to be connected to either a first PC 120 or a second PC 122. Switching between the PCs 120 and 122 is typically achieved through a user selection of a button on the KVM switch 130 or through application of a specific key-press combination on the keyboard 140.

While the first PC 120 or the second PC 122 is not connected to the keyboard 140 and mouse 150, the KVM switch 130 simulates the presence of such input devices so that these computers do not generate errors or notifications regarding the lack of a keyboard and a mouse. Traditional KVM devices support analog VGA displays, PS/2 keyboards and PS/2 mice. In recent years, keyboards and mice have migrated to USB (Universal Serial Bus) connections, with displays migrating to DVI (Digital Visual Interface) or HDMI (High-Definition Multimedia Interface) connections. The KVM industry has responded to these changes and now offers KVM products that also support DVI, HDMI and USB connections.

In lieu of a KVM switch, a monitor with multiple inputs (multi-input monitor) may be used. Lower-end, older consumer monitors tend to be limited to one VGA (Video Graphics Array) and one DVI-D (DVI-Digital) connection for video inputs. However, many newly manufactured monitors include at least two display signal input channels to allow, for example, two PCs to share a single monitor. A typical setup of using monitor switching is illustrated by the system 200 in FIG. 2. As shown, only the monitor 210 is shared between a first PC 220 and a second PC 222, with the keyboards 230, 250 and the mice 240, 260 being duplicated to provide each of the PCs 220 and 222 with one keyboard 230, 250 and one mouse 240, 260. An advantage of using a monitor with multiple inputs is that it is a very cost effective solution and does not degrade video quality. For example, a typical 30-inch business monitor has three DVI-I inputs, a desirable feature for high-end monitor users. However, the convenience of a KVM switch is lost because the keyboard and mouse are not managed and need to be externally and independently switched.

Alternatively, as illustrated by the system 300 in FIG. 3, it is possible to share a keyboard 340 and a mouse 350 by again adding a separate KVM switch 330. In this scenario, the monitor switching and KVM switching are independent and need to be synchronized by the user. This is often confusing, however, because the monitor 310 and the KVM switch 330 may not use the same input (e.g., one may use a toggle, the other may use direct buttons or key-presses), and they may not show their switching states the same way. In addition, the video selection or switching feature within the KVM switch 330 is not connected, and thus, the video selection or switching feature circuit adds to the cost and the power consumption of the KVM switch 330 without an added benefit.

Similar problems exist with conventional KVM solutions for sharing multiple monitors. The most commonly used multi-monitor KVM solutions are derived by users mixing independent features of a KVM switch with the integrated input selection features of their multi-input monitors. That is, monitors are each individually switched using their integrated source selection feature/button. In addition, a separate KVM switch is typically used to switch input devices, such as a keyboard and a mouse, for use with two or more computers that provide information display to the multiple monitors.

FIGS. 4A and 4B, respectively, illustrate systems 400 and 450 having a typical implementation for multi-monitor switching as noted above. The systems 400 and 450 include two monitors, Monitor1 (410) and Monitor2 (412), that are connected to multiple computers, namely, PC1 (420) and PC2 (422). The systems 400 and 450 also each includes a KVM switch 430 and input devices, such as a keyboard 440 and a mouse 450. Performing dual display switching between two host PCs (410 and 412) in the systems 400 and 450 requires multiple independent device selections. First, the user must manually switch an input selection on each monitor and also must switch the keyboard 440 and mouse 450 using the external KVM switch 430 (via a switch selection on the KVM switch 430 or a dedicated key press sequence programmed for the keyboard 440). In such a situation, it is easy for the various input/output/display devices to be out of sync with each other, and consequently presents an inconsistent and potentially confusing UI to the user. In addition, the video selection or switching feature within the KVM switch 430 is not connected, and thus, the video selection or switching feature circuit adds to the cost and the power consumption of the KVM switch 430 without an added benefit. Moreover, there exists a small number of external KVM products that support multiple monitors (as opposed to widely-available KVM products that support single-monitor sharing), but these are rare and expensive devices that often have image quality issues.

Consequently, the conventional monitor-sharing solutions discussed above are typically unsatisfactory because KVM products are notorious for being expensive, finicky, and for degrading image quality. Further, a multi-input monitor does not manage the keyboard and mouse switching for user interface (UI) or user input. This often results in multiple keyboards and mice, or independent switching of the monitor and/or KVM-linked input devices (keyboard, mouse, etc.).

Accordingly, it would be desirable to provide a monitor sharing solution for single and/or multi-monitor setups that is simple, user-friendly, and satisfactory to users.

### BRIEF DESCRIPTION OF THE DRAWINGS

Embodiments are illustrated by way of example and not limited in the following figure(s), in which like numerals indicate like elements, in which:

FIG. 1 illustrates a typical desktop KVM (Keyboard, Video, Mouse) system;

FIG. 2 illustrates typical video switching provided by a multi-input monitor;

FIG. 3 illustrates a typical monitor-sharing setup that includes video switching at the multi-input monitor as well as device switching at an external KVM switch;

FIGS. 4A and 4B, respectively, illustrate typical implementations for a multi-monitor switching that uses an external KVM switch;

FIG. 5 illustrates a monitor-sharing system in which the KVM functionality is integrated within a monitor, in accordance with an embodiment of the invention;

FIG. 6 illustrates a diagram of the internal logic of a KVM-monitor, in accordance with an embodiment of the invention;

FIG. 7A illustrates a KVM-monitor system for sharing multiple monitors across multiple PCs, in accordance with an embodiment of the invention;

FIG. 7B illustrates a diagram of an inter-monitor communication channel for a dual-display operation, for instance, the KVM-monitor system depicted in FIG. 7A, in accordance with an embodiment of the invention;

FIG. 7C illustrates a KVM-monitor system for sharing multiple monitors across multiple PCs, in accordance with another embodiment of the invention;

FIG. 7D illustrates a diagram of an inter-monitor communication channel for a dual-display operation, for instance, the KVM-monitor system depicted in FIG. 7C, in accordance with another embodiment of the invention;

FIG. 8A illustrates a KVM-monitor system for sharing multiple monitors across multiple PCs, in accordance with another embodiment of the invention;

FIG. 8B illustrates a diagram of an inter-monitor communication channel for a dual-display operation, for instance, the KVM-monitor system depicted in FIG. 8A, in accordance with another embodiment of the invention;

FIG. 9 illustrates a diagram in which a dedicated wired link is added between monitors for inter-monitor communication, in accordance with an embodiment of the invention;

FIGS. 10A and 10B, respectively, illustrate various configurations of multiple monitors connected to each other for sharing, in accordance with an embodiment of the invention;

FIG. 11 illustrates a diagram of a multi-monitor arrangement that uses proximity wireless communication for inter-monitor communication and monitor sharing, in accordance with an embodiment of the invention; and

FIG. 12 illustrates a diagram of a multi-monitor arrangement in which each monitor is equipped with Bluetooth™ capability for wireless communication with each other, in accordance with an embodiment of the invention.

### DETAILED DESCRIPTION

For simplicity and illustrative purposes, the principles of the embodiments are described by referring mainly to examples thereof. In the following description, numerous specific details are set forth in order to provide a thorough understanding of the embodiments. It will be apparent however, to one of ordinary skill in the art, that the embodiments may be practiced without limitation to these specific details. In other instances, well known methods and structures have not been described in detail so as not to unnecessarily obscure the embodiments.

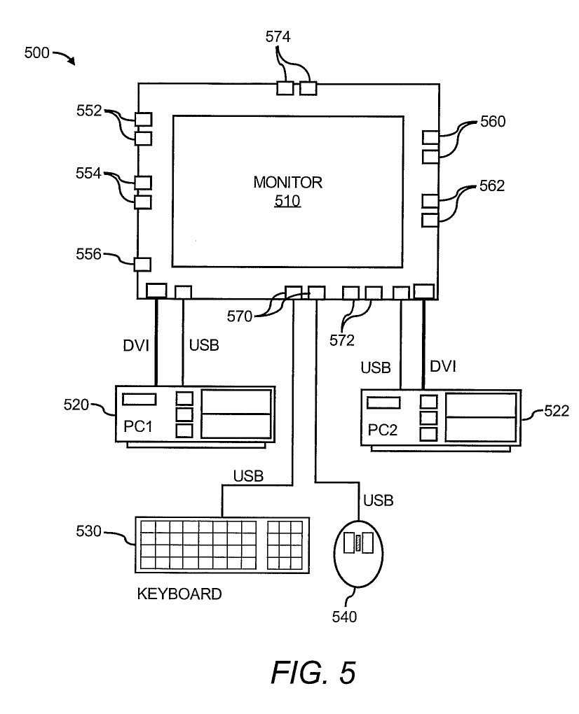

With reference first to FIG. 5, there is shown a monitor-sharing system 500 in which the functionality of a KVM is integrated within a monitor, in accordance with one embodiment. The system 500 depicted in FIG. 5 avoids complications typically found in conventional monitor-sharing solutions, such as the use of multiple input devices for multiple computers and the required independent switching of KVM-linked input devices that causes such devices to be out-of-sync. According to this embodiment, the integration of KVM functionality within the monitor 510 results in a “KVM-monitor” that offers the convenience of a true KVM while avoiding the need for independent switching of an external KVM switch.

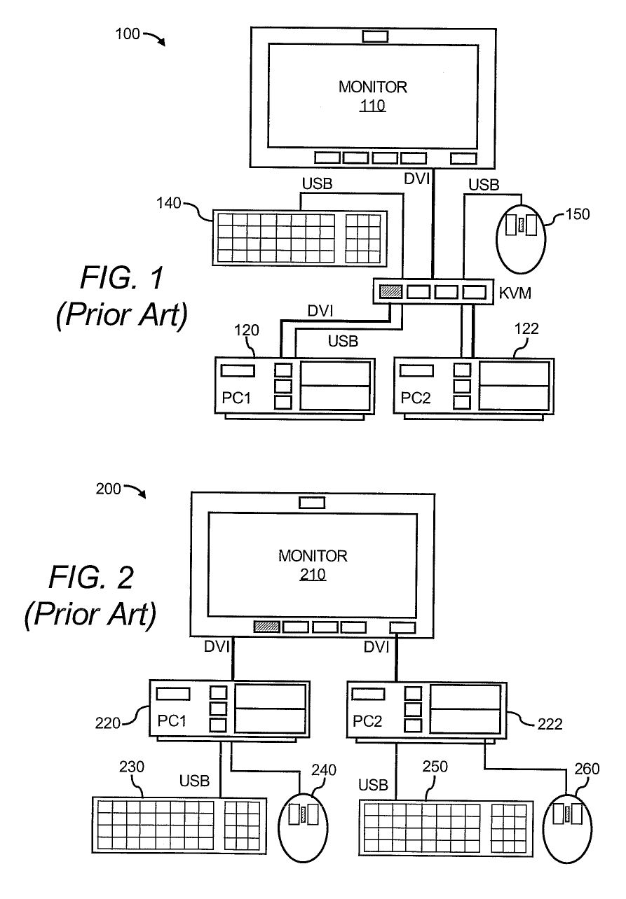

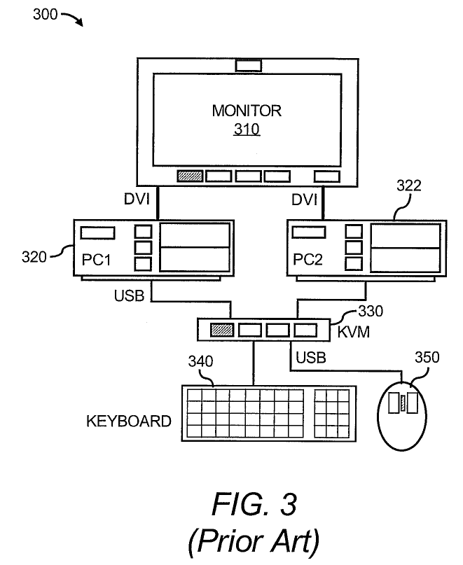

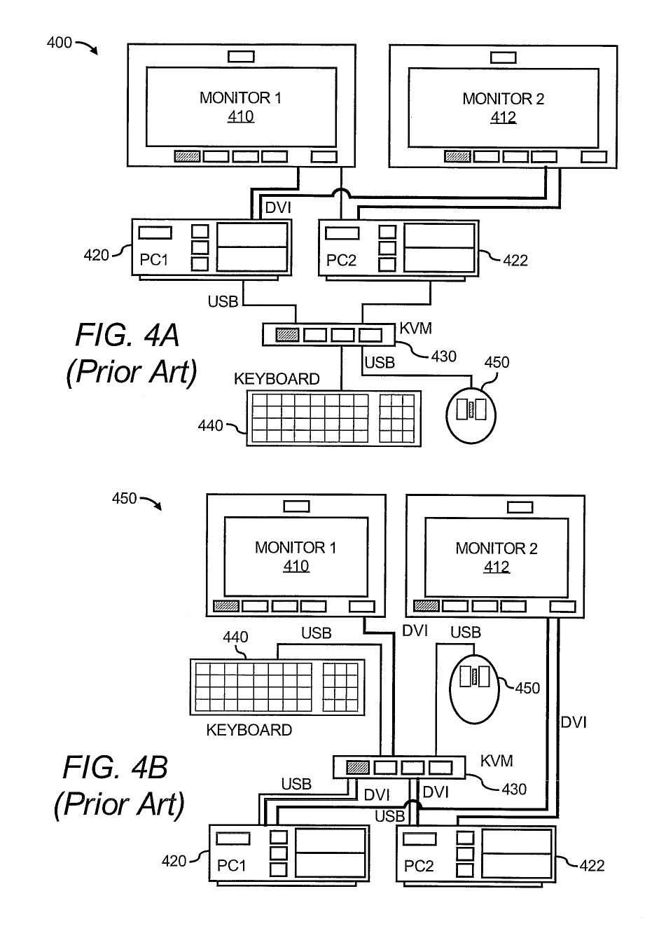

As shown in the system 500 in FIG. 5, there is provided a single monitor 510 for sharing between two computers, namely, PC1 (520) and PC2 (522), which are connected to the monitor 510 without going through an external KVM switch. Input devices, such as a keyboard 530 and a mouse 540 are also provided. Unlike the conventional arrangements shown in FIGS. 1-4B, the input devices 530 and 540 are connected directly to the monitor 510 without going through an external KVM switch or the computers PC1 and PC2.

In addition, and as noted above, the monitor 510 is a “KVM-monitor” that is based on many newly-manufactured monitors, which already contain the functionality to switch between multiple monitor inputs (such as, HDMI, DVI-I, DVI-D, and/or DVI-A, etc.). They also typically contain a USB hub, with a single input port and multiple output ports. Therefore, the KVM-monitor 510 may be one of such monitors, modified to include an additional USB input port to provide a connection to the second computer PC2 522. The KVM-monitor 510 may also include a pair of additional dedicated USB output ports, such as 2 USB inputs for the keyboard 530 and the mouse 540). The KVM-monitor 510 also has the ability to appropriately switch USB port signals (to accommodate switching between the computers PC1 and PC2). Additionally, the monitor input switching and USB switching functions may be internally linked so that both switch together. Furthermore, USB switching may be optional so as to allow users that do not desire or require the KVM functionality to use the USB connectors as a standard USB hub (as with current existing monitors), and only the monitor inputs, such as, DVI, HDMI, etc., may be switched.

Accordingly, the number of shared-connections to the monitor 510 depends on the number of available monitor inputs and on the provisioning of a matching number of USB input ports, together with at least a pair of dedicated or switching USB output ports (or, generally, interfaces for input devices) that the monitor enclosure are physically able to accommodate.

For the KVM-monitor setup described above, various user-customizable USB port options and advanced configurations are possible. Existing monitors, with integrated USB hubs, associate all USB ports on the monitor to a single host PC. In the KVM-monitor case, port assignments may be matched to device routing, for example, by assigning all USB ports to the user's currently selected PC. However, the KVM-monitor 510 may afford users with greater flexibility and control over the individual USB port assignments.

For example, device switching may always re-route certain devices, such as input devices like the keyboard and mouse. However, a user may wish that other specific devices remain connected to one PC (for example, external storage drive(s) that are attached to one or more USB ports of the monitor), independent from the device switching. In one embodiment, USB port control features within the monitor's on-screen control panel may be provided to achieve this level of control. This level of control provides the user with the option to independently configure each output (or downstream) USB port's behavior, allowing these individual USB ports to be switched with the device or to be assigned to a specific upstream USB port (as a standard USB hub).

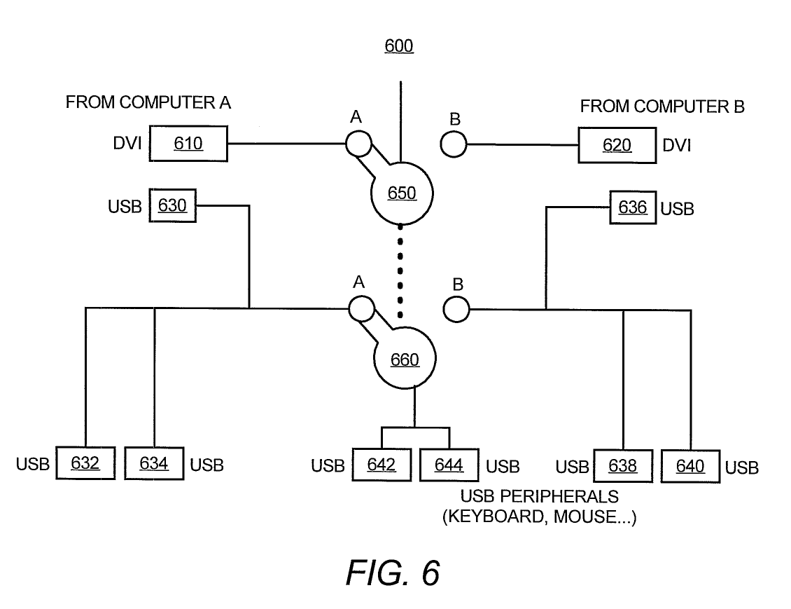

In another embodiment, the functionality of the USB ports on the monitor 510 may be locked based on the physical location or position of the USB ports on the monitor 510 or on behavior grouping. For example, the monitor 510 may have multiple USB ports 552 and 554 located on the left side, USB ports 560 and 562 located on the right side, USB ports 570 and 572 located on the bottom, and USB ports 574 located on the top of the monitor 510. In this example, all of the USB ports 552 and 554 located on the left side of the monitor 510 are dedicated to one PC or device, and all of the USB ports 560 and 562 located on the right side of the monitor are dedicated to a second PC or device. In addition, the remaining USB ports 570, 572, and 574 along the bottom and the top of the monitor 510 may be associated with either a first PC 520 or a second PC 522. Thus, in this example, the spatial locations of the USB ports determine their operations without implementing port configuration features in the monitor's on-screen control panel. In addition, the monitor 510 may include labels (for instance, as shown in FIG. 6) for the USB ports 552-556, 560, 562, and 570-574 that enable the functionalities of the USB ports 552-556, 560, 562, and 570-574 to be easily distinguished from each other. The labels may include text, for instance, “From Computer A” and “From Computer B”. In addition, or alternatively, the labels may include other distinguishing characteristics, such as, different colors, shapes, etc.

According to a further example, some of the USB ports 552, 560, 570, and 574 may be configured to become powered when either of the PCs 520 and 522 are active. In addition, other ones of the USB ports 562, 564, and 572 may be configured to remain powered regardless of which of the PCs 520 and 522 is active. Still others of the USB ports 556 may be configured to remain active regardless of which of the PCs 520 and 522 is active and these USB ports 556 are not associated with either of the PCs 520 and 522.

FIG. 6 illustrates a diagram 600 of the internal logic of a KVM-monitor, such as the monitor 510, to show how various components are linked, in accordance with one embodiment. As shown, the monitor includes 2 DVI ports 610 and 620, 8 USB ports 630-644, a DVI switch 650, and a USB switch 660. It should however be understood that the monitor may include any suitable number of DVI ports, USB ports, DVI switches, and USB switches without departing from a scope of the invention.

The DVI switch 650 and the USB switch 660 are internally linked so that both switch together, as initiated by a user via, for example, a dedicated button pressed on the monitor itself or the monitor's on-screen control panel. Alternatively or additionally, the monitor 510 may be set up or programmed such that the user may initiate the switch by performing a predetermined key-press sequence, e.g., hot key(s), or through a trigger device switching (e.g., once an input device such as a keyboard or mouse is connected to a USB port, the monitor 510 detects such a connection and automatically switches so as to enable a corresponding A or B configuration to which the USB port belongs).

Based on the user selection through any of the aforementioned modes, the monitor may be switched to the A or B configuration, to switch the display information from computer A (e.g., PC1 520 in FIG. 5) or computer B (e.g., PC2 522 in FIG. 5) to the monitor's screen. As a result, the connection from either DVI 610 or 620 becomes active and is displayed by the monitor 510. In addition, each computer also connects to a single USB input port, namely PC1 520 connects to USB port 630 and PC2 522 connects to USB port 636. User selection to the A or B configuration, in parallel with the display switching, results in one of the two USB input ports 630 and 636 connecting to the shared output USB port pair 624 and 644. With the switch in the A position, input (upstream) USB port 630 connects to output (downstream) USB ports 642 and 644. Likewise, with the switch in the A position, input (upstream) USB port 630 connects to output (downstream) USB ports 632 and 634. Hence this pair of switching output or downstream USB ports is suitable for input of other devices (e.g., keyboard, mouse, etc.) that the user wishes to share between the two host computers, in sync with the display switching.

In the case where the user wishes to circumvent the port switching process, peripherals that connect to output (downstream) USB ports 632, 634, 638 and 640 do not switch with the A or B configuration selection. As shown in FIG. 6, the output USB port pair 632 and 634 are internally wired to USB input port 630 (e.g., PC1 520 from FIG. 5), whereas the output USB port pair 638 and 640 are internally wired to USB input port 636 (e.g., PC2 522 from FIG. 5).

Existing monitors with integrated USB hubs typically include automatic power control of the USB hub. That is, the USB hub is typically powered down (switched off) to be in sync with the monitor. Although this may save a little power, this may be an undesirable feature in many instances, for example if the host PC is performing a data back-up operation to an attached USB drive when the monitor decides to sleep. Hence, in one embodiment, the KVM-monitor 510 provides the user with an option to override the automatic power control of the USB hub so as to leave one or more USB ports permanently powered, for example, to charge a wireless phone or personal digital assistant (PDA).

In many multi-monitor arrangements, especially for workstation configurations, users may connect their machines to multiple displays in order to increase the overall display area. One common configuration is to have a single computer, such as a PC (equipped with a multi-display graphics card), rendering an extended desktop display across multiple monitors. Hence, the aforementioned embodiments for sharing a single monitor may be extended for sharing multiple monitors across multiple devices, such as PCs. While various embodiments as described herein make reference to a system having two monitors and two PCs, it should be understood that such embodiments are scalable to accommodate more monitors and/or PCs (or other devices).

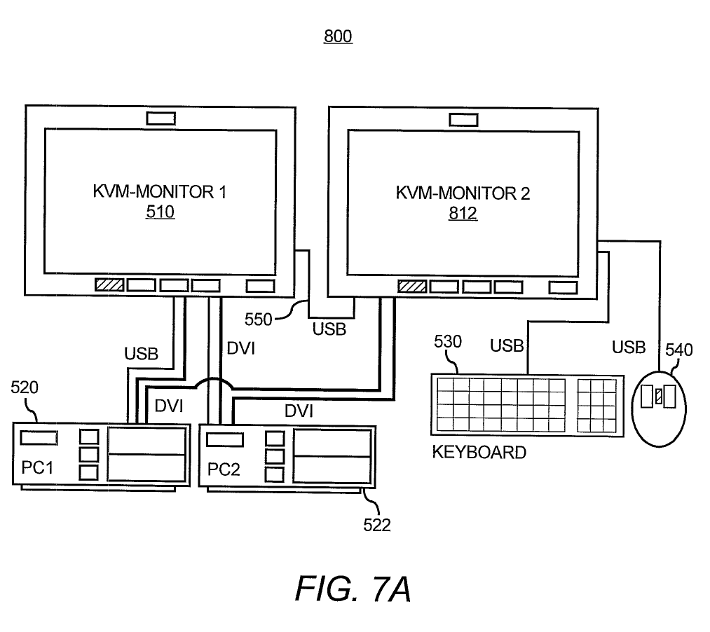

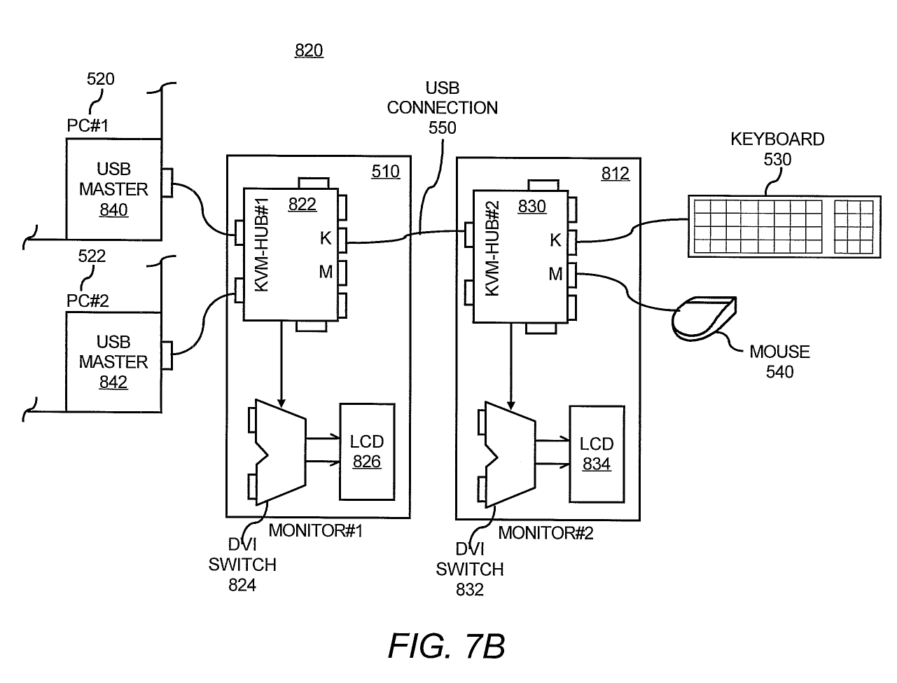

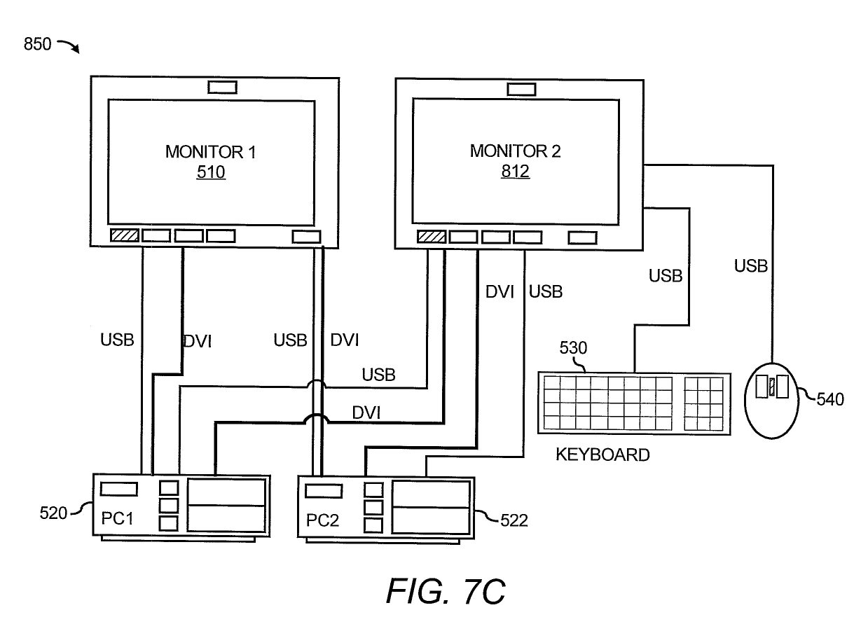

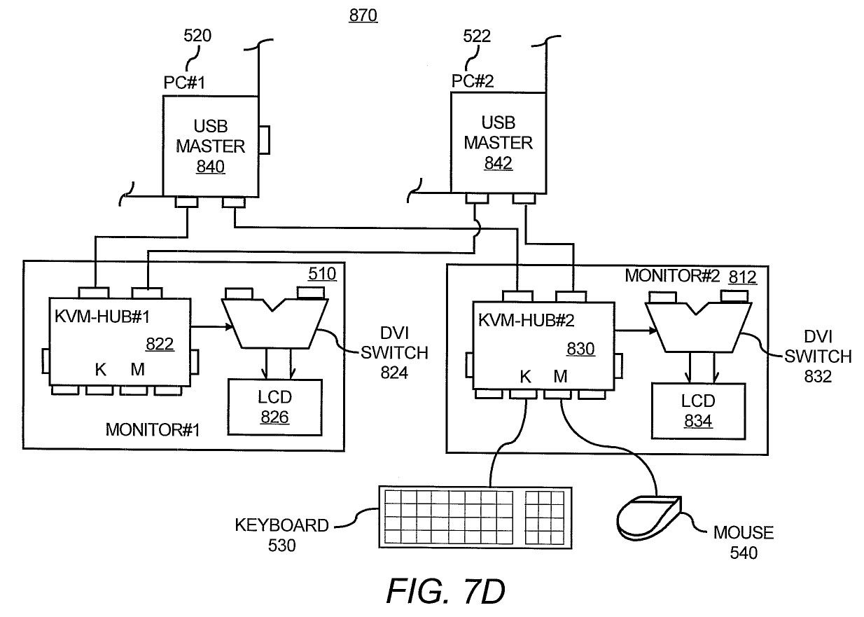

FIG. 7A illustrates a KVM-monitor system 800 for sharing multiple monitors across multiple PCs, in accordance with another embodiment. As shown therein, the first monitor 510 and the second monitor 812 are KVM-monitors. In addition, the keyboard 530 and the mouse 540 are depicted as being connected to the second monitor 812. At least one of the USB ports of first monitor 510 and at least one of the USB ports of the second monitor 812 are arranged in a hierarchical tree architecture, in which the at least one of the USB ports on the first monitor 510 and the at least one of the USB ports on the second monitor 812 comprise leaf nodes of the hierarchical tree architecture, and in which the leaf node of the at least one USB port on the first display monitor is at a higher level than the at least one USB port on the second display monitor. A host node of the hierarchical tree architecture may be contained in both of the PCs 520 and 522. In addition, the keyboard 530 and the mouse 540 are depicted as being connected to the leaf node USB ports of the second monitor 812. The arrangement depicted in FIG. 7A enables an input switch in both of the monitors 510 and 812 to be triggered through, for instance, a key stroke or button activation, on an input device. In one regard, the hierarchical tree architecture of the USB ports enables a signal from the input device, such as, the keyboard 530 and the mouse 540, to be propagated through each of the monitors 510 and 812 prior to going to the host, such that the monitors 510 and 812 are synched together, for instance, as also shown in FIG. 7B.

From a user's perspective, this KVM-monitor arrangement provides the convenience of a complete KVM switchover that is to occur across all of the monitors upon a single user action, such as at the press of monitor button or keyboard key-press sequence. That is, both the KVM-Monitor1 510 and the KVM-Monitor2 812 synchronize their switching so that when the user switches the input on one KVM-monitor, the other KVM-monitor switches accordingly. This is accomplished through creation of a communication channel between the KVM-monitors 510 and 812, as facilitated by the USB connection 550 that uses existing USB ports on the monitors 510 and 812. This communication channel facilitated by the USB connection 550 may be used by the KVM-monitors 510 and 812 to inform each other of their state changes and to monitor state changes of other KVM-monitors. It also enables functions and parameters to be coordinated across multiple monitors. For example, the monitors may be synchronized with respect to their on/off switching so that the user only needs to press one on/off button to switch all of the monitors on or off. Also, the monitors may be synchronized with respect to their brightness, contrast, color, temperature, language or other device specific configuration settings. The aforementioned inter-monitor communication channel may be scalable to any number of monitors and independent of devices such as PCs that are connected thereto.

FIG. 7B illustrates a diagram 820 of an inter-monitor communication channel for a dual-display operation, such as the one shown in FIG. 7A, wherein integrated-KVM switching is performed based on key-press sequences or events (via the keyboard). Each of the KVM-Monitor1 (510) and KVM-Monitor2 (812) includes a KVM-Hub (822 and 830) to provide the integrated KVM functionality as described above, a DVI switch (824 and 832) to provide the multi-input functionality, and a display such as a liquid crystal display (LCD) (826 and 834) for displaying information. For simplicity purposes, connections between the PC1 and PC2 to both DVI switches 824 and 832 are not illustrated in FIG. 7B. For such a dual display operation, the two integrated KVM-hubs 822 and 830 may be chained together to create a communications path between the two monitors 510 and 812. As illustrated, both PC1 (520) and PC2 (522) are connected to the first monitor, KVM-Monitor1 (510), and the keyboard 530 and mouse 540 are connected to the second monitor, KVM-Monitor2 (812). This enables the USB hub hierarchy to be maintained and the key-press sequence commands to pass from the (downstream) keyboard 530 through both (upstream) KVM-monitors to the selected host PC via its respective USB master port (840 or 842).

The USB connection 550, such as a USB cable link, between the two KVM-monitors 510 and 812 forms a master-slave hub relationship. Normal keyboard and mouse usage is routed back to the selected PC (PC1 or PC2) via the two integrated USB Hubs 822 and 830. Both KVM-monitors 510 and 812 have specific USB keyboard and mouse ports and have the ability to act as a keyboard and mouse proxy. For example, at power up (or turn on), KVM-Monitor1 (510) may send a special command or identification while initializing its keyboard port. This initialization may be ignored by standard keyboards but recognizable by KVM-Monitor2 (812), and it is used to disable the USB switching in KVM-Monitor2. Thus, KVM-Monitor2 is slaved to KVM-Monitor1 with respect to the switching of PC1 and PC2 for use with the keyboard 530 and mouse 540. Then, upon recognizing a key-press command sequence from the keyboard 530, KVM-Monitor2 switches its display input channel (via its DVI switch 832) and also forwards the key-press command to the upstream KVM-Monitor1. In turn, KVM-Monitor1 interprets the key-press sequence and also switches its display input channel (via its DVI switch 824), switches its USB KVM to select an alternate one of PC1 and PC2 as the new host.

The keyboard proxy of KVM-Monitor1 is configured to block the actual key-press command sequence from being passed to the selected host PC. To avoid incorrect switching, the downstream KVM-Monitor2 may append the current (new) display input channel to the key-press command sequence that is sent to the upstream KVM-Monitor1 to ensure a correct switching of the monitor. Alternatively, the command sequence may include a command to switch the monitor for viewing.

FIG. 7C illustrates a KVM-monitor system 850 for sharing multiple monitors across multiple PCs, in accordance with another embodiment. The KVM-monitor system 850 depicted in FIG. 7C is similar to the KVM-monitor system 800 depicted in FIG. 7A. As such, only those features that differ from the KVM-monitor system 700 will be described with respect to the KVM-monitor system 850.

Initially, instead of connecting only to the KVM-hub 822, the USB masters 840 and 842 of the PCs 520 and 522 are connected to both of the monitors 510 and 812 and are thus configured to interface with any attached peripheral or input device. In addition, the monitors 510 and 812 do not connect through to each other, but instead, rely on the host(s) 840 and 842 to determine the relationships between the monitors 510 and 812 and the input devices 530 and 540.

As all KVM-monitors have an internal controller, software drivers may be installed in the host PC(s) to issue commands to perform the appropriate KVM switching. Thus, when a PC performs an enumeration of the USB bus, it may detect how many KVM-monitors are connected to the host computer and may configure each appropriately (switch only the display or both the display and USB). The PC is aware of all the monitors (and controllers thereof) connected to the USB tree and therefore may receive state messages from any connected monitor, and may trigger switching on all of the monitors.

FIG. 7D illustrates a diagram 870 of an inter-monitor communication channel for a dual-display operation, such as the one shown in FIG. 7C, wherein integrated-KVM switching is performed based on key-press sequences or events (via the keyboard). The diagram 870 of FIG. 7D includes all of the features of the diagram 820 depicted in FIG. 7B. As illustrated, both PC1 (520) and PC2 (522) are connected to both the first monitor, KVM-Monitor1 (510) and the second monitor, KVM-monitor2 (812), and the keyboard 530 and mouse 540 are connected to the second monitor, KVM-Monitor2 (812). This configuration also enables the USB hub hierarchy to be maintained and the key-press sequence commands to pass from the (downstream) keyboard 530 through both (upstream) KVM-monitors to the selected host PC via its respective USB master port (840 or 842).

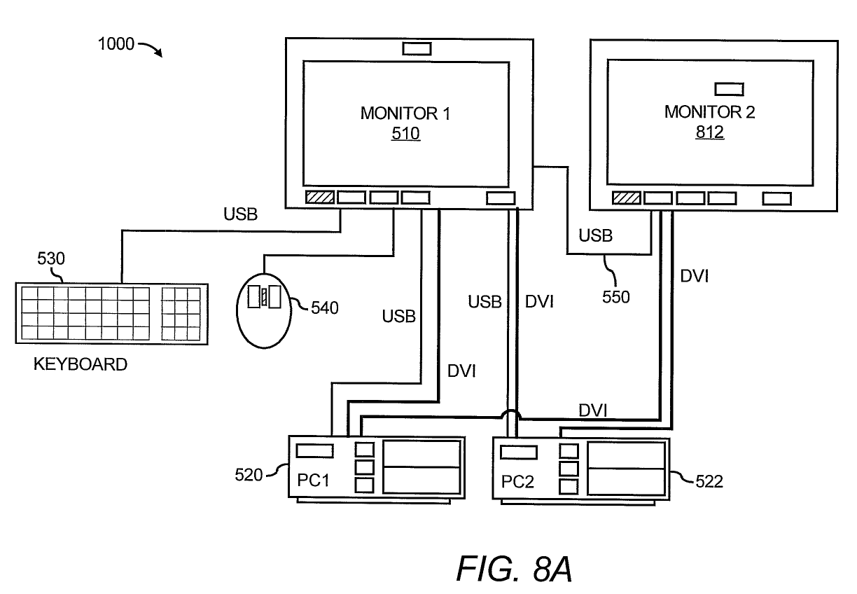

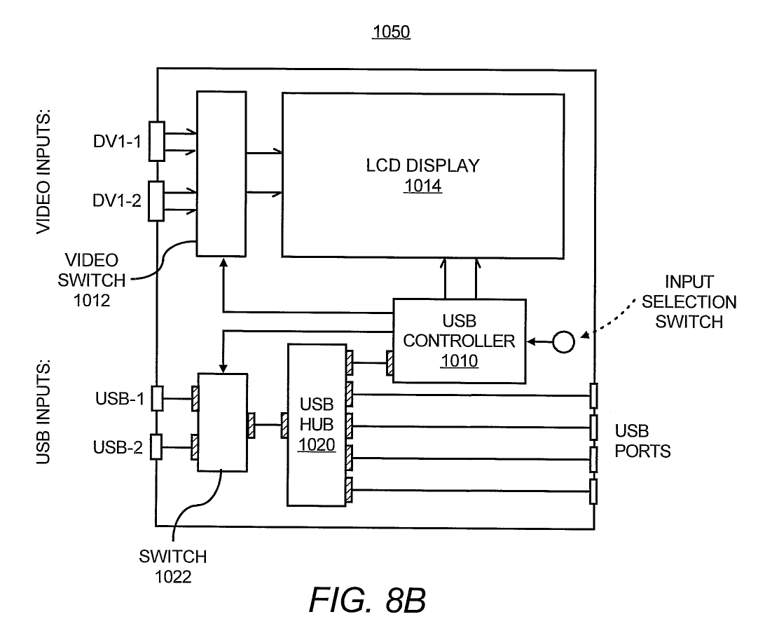

FIG. 8A illustrates a KVM-monitor system 1000 for sharing multiple monitors across multiple PCs, in accordance with another embodiment. The KVM-monitor system 1000 depicted in FIG. 8A is similar to the KVM-monitor system 800 depicted in FIG. 7A. As such, only those features that differ from the KVM-monitor system 800 will be described with respect to the KVM-monitor system 1000.

As shown in FIG. 8A, the input devices 530 and 540 are depicted as being connected to the first monitor 510. Assuming that the USB ports in the PCs 520 and 522 and the monitors 510 and 812 are in the hierarchical connection tree arrangement as discussed above, the first monitor 510 is at a higher level than the second monitor 812. Thus, signals received from the input devices 530 and 540 may not be relayed to the second monitor 812 under the connection arrangements depicted in FIGS. 7A-7D. To overcome this situation, each of the monitors 510 and 812 is equipped with an embedded USB (slave) microcontroller for display and connection switching, as shown in FIG. 8B.

As is generally known with USB connections, the USB protocol does not let devices communicate directly with each other and thus, the devices are intended to be pure slaves to a PC. In order to overcome this restriction, according to an example, one or both of the KVM-monitors 510 and 812 is equipped with USB master support to enable direct communication of information between the KVM-monitors 510 and 812 without having to go through one of the PCs 520, 522. In another example, the USB protocol may be modified to enable such communications. In a further example, the KVM-monitors 510 and 812 may be equipped with specialized USB chips to enable the direct communication between the KVM-monitors 510 and 812.

FIG. 8B, more particularly, illustrates a component diagram 1050 detailing components in each KVM-Monitor 510 and 812 used in a setup of an inter-monitor communication channel for a multi-display operation, such as the one shown in FIG. 8A, wherein integrated-KVM switching is performed based on the user selecting an input source, via either a button or the on-screen control panel, on any connected monitor instead of a key-press sequence or event. For this setup, each of the connected monitors, KVM-Monitor1 510 and KVM-Monitor2 812, includes a dedicated USB microcontroller 1010 integrated therein. Connected devices, such as PC1 520 and PC2 522, may be used to relay events between those controllers. Again, the USB ports of the two monitors may be chained together via the USB connection 550. However, there are no dedicated USB ports on each monitor, and the keyboard 530 and mouse 540 may be connected to any USB port of the two monitors. For example, instead of having the keyboard 530 and mouse 540 connected to KVM-Monitor2, as illustrated in FIG. 7A, these input devices may be connected to KVM-Monitor1, as illustrated in FIG. 8A.

The microcontroller 1010 in each of the KVM-monitors 510 and 812 has access to and control over the LCD video input switching (as performed by the video switch 1012, which is similar to the DVI switch 824 or 832 in FIGS. 7B and 7D, for display on the LCD 1014). The controller 1010 is located on the downstream side of the monitor's integrated USB hub 1020, which may include an extra USB port to accommodate the controller 1010. The controller 1010 is also responsible for the upstream USB connectivity, via the USB switch 1022 on the upstream side of the hub.

According to a further example, one or both of the monitors 510 and 812 includes intended USB master functionality. In this example, either or both of the monitors 510 and 812 may assume the role of the USB master and thus may control on the downstream devices. The USB master functionality may be stored on a computer-readable medium as software.

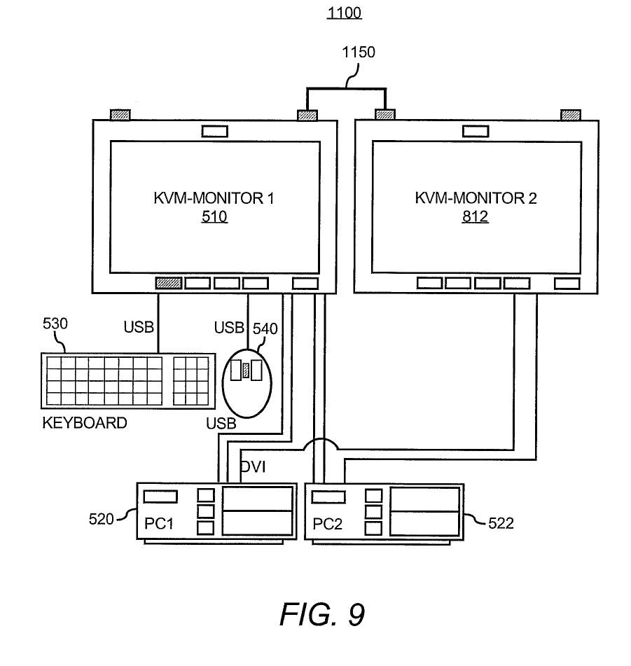

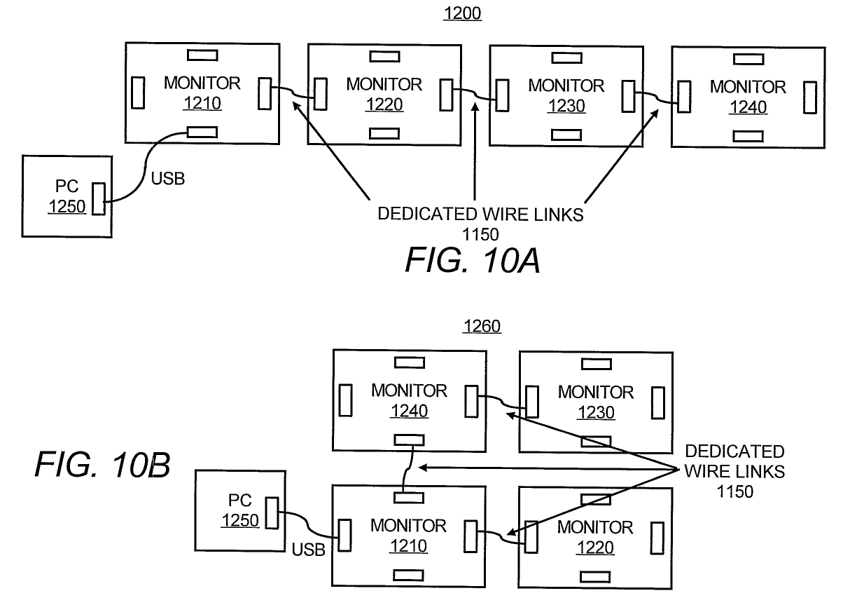

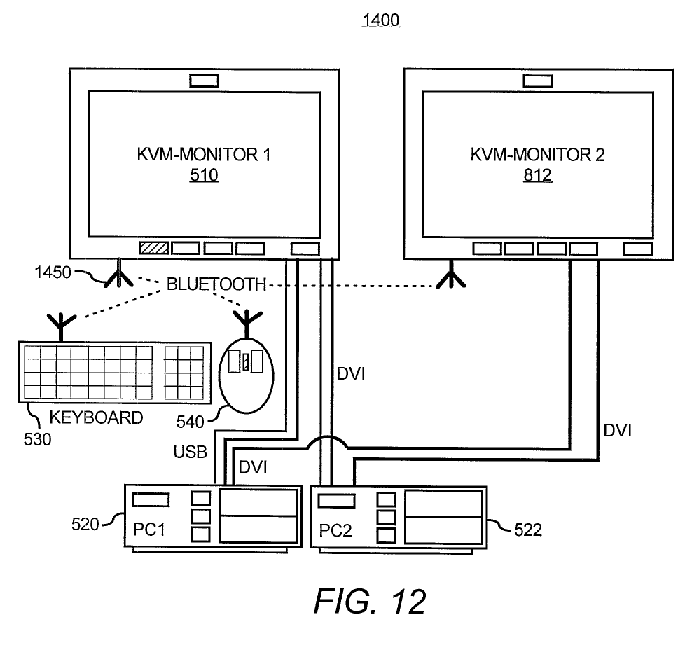

With reference now to FIG. 9, there is shown a diagram 1100 in which a dedicated communication link 1150 is added between monitors 510 and 812, which is an alternative to using a USB connection for inter-monitor communication as depicted in FIG. 7A. As such, each of the monitors 510 and 812 includes a dedicated interface for enabling the dedicated communication link 1150 between the monitors 510 and 812. The dedicated communication link 1150 may adopt one of the low-cost serial data transfer standards to create the data path (e.g. I2C, SPI, RS-485 or 1-wire), or it may use USB or another direct data connection method. Hence, each KVM-monitor 510, 812 includes additional connectors (for link input and output) for such a wired link 1150 that serves to simplify the data transfer process (without interfering with or modifying the USB/KVM chipset in each monitor). Furthermore, numerous monitors may be chained together using either a common electrical connection (e.g., as in the case of 1-wire bus solutions) or as a series of shorter one-to-one links (e.g., as in the case of SPI solutions). Examples of these arrangements are shown by the quad-display examples 1200 and 1260, respectively, in FIGS. 10A and 10B, which show KVM-monitors 1210, 1220, 1230, and 1240 chained together by dedicated wired links 1150. Each of the KVM-monitors 1210-1240 is similar to the KVM-monitor 510 described earlier. Also, multiple devices, such as PCs may be connected to one or more of the KVM-monitors. For simplicity, FIGS. 12A-B only show one PC 1250 connected to one of the KVM-monitors. In one embodiment, different colored and shaped connector types for the “in” and “out” ends of these monitor links may help to avoid user configuration errors.

The dedicated communication link 1150 allows the KVM-monitors 1210-1240 to act as peers; thus, user-input changes to any one monitor may be propagated to all of the other connected monitors. The dedicated communication link 1150 also provides an option to connect multiple sets of keyboard and mouse pairs, each to a different monitor, to allow the user to switch between them. Additionally, by placing connectors on each side of the monitor, the monitor links may provide information regarding the relative location of each monitor and propagate this information back to the host PC. Various manners in which the respective locations of each of the monitors 1210-1240 may automatically be identified are described in greater detail herein below. In one regard, therefore, the respective locations of each of the monitors may automatically be identified, which eliminates the trial-and-error approach to multi-monitor configuration, allowing the monitors to inform the host of their spatial relationship with respect to each other on the desktop (or other setting). For example, FIG. 10A shows four KVM-monitors 1210-1240 in a horizontal (or single-line) distribution, and FIG. 10B shows a tiled (2×2) configuration. In each spatial configuration, the inter-monitor connections via the dedicated wired links to respective connectors on the KVM-monitors provide the host PC 1250 with information identifying their aggregated configuration. This allows the host PC 1250 to modify the distribution of video signals to each display, according to their relative position. In addition, it may be possible to use the same data to provide approximate location information for attached peripherals, for example USB microphones, speakers and webcams. Such data may allow auto-configuration and re-direction of their behaviors. For example, two identical USB speakers may be placed to the left and right side of the KVM-monitors, with some speakers acting as both a right speaker for one monitor and a left speaker for an adjacent monitor. Then, left and right channel audio may be automatically assigned to each speaker based on monitor switching.

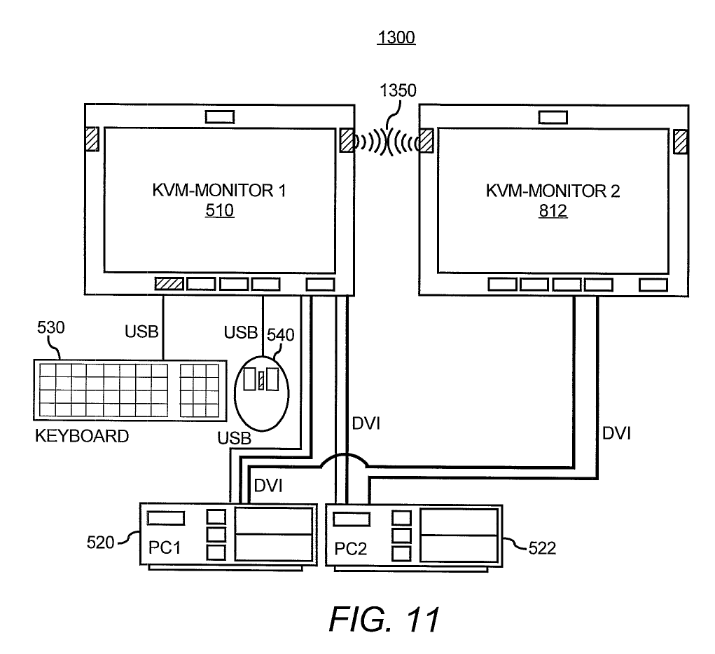

An alternative to the dedicated wired solution may be implemented by using short range wireless communications, whereby each KVM-monitor may have integrated therein one or more wireless transceiver IC (Integrated Circuit) chips. FIG. 11 illustrates a diagram 1300 of a multi-monitor arrangement that uses proximity wireless communication 1350 as a dedicated communication link between each monitor, in accordance with one embodiment. This proximity wireless communication may be facilitated by NFC (Near Field Communications), RFID (Radio Frequency Identification), or other radio frequency or modulated light technologies, which have evolved to allow bi-directional data flow between pairs of closely located active transducers.

In one embodiment, proximity data link antennas may be deployed or mounted along both sides of a monitor enclosure. Auto-detect functionality may operate to determine the presence of an adjacent monitor and allow input switching and other parametric data to be shared between the monitors. As with the use of dedicated wired links discussed above, the wireless communication may be independent of the current state of the host PCs. Consequently, KVM switching may be initiated by the user selecting an input selection button or an input selection in an on-screen control panel of any of the connected monitors, or optionally by entering an appropriate keyboard key-press sequence. Many existing standardized low power RF protocols may be used to implement the aforementioned wireless communication links between KVM-monitors.

FIG. 12 illustrates a diagram 1400 of a multi-monitor arrangement, in which each monitor is equipped with Bluetooth™ capability (e.g., a Bluetooth™ radio chip) for wireless communication 1450, in accordance with one embodiment. As illustrated, the KVM-Monitor1 (510) is the Bluetooth™ master and may be USB connected to one or more host PCs, PC1 (520) and PC2 (522), via a 2×2 cross-point switch. This allows the upstream USB signals to be connected to either the internal multi-port USB hub or the internal Bluetooth™ module of the monitor. Other USB routing options may be implemented to allow the host PCs to access both the USB hub and the Bluetooth™ functionality in the monitor. KVM-Monitor2 (812), which is not connected via USB to either host PC, becomes a Bluetooth™ slave, as do the keyboard 530 and mouse 540. These wireless communication links create a network (Personal Area Network) connecting these input devices and the KVM-monitors 510, 812 to one of the selected PCs. However the Bluetooth™ controller in KVM-Monitor1 510, as the master, controls the PAN communications and can interpret KVM selection requests from any monitor input buttons or from keyboard key-press commands, regardless of the connected PC status. As in the previously described cases, the Bluetooth™ master collates status information for all the grouped devices and issues commands to switch all of these devices to the appropriate state.

Accordingly, various embodiments as described herein provide an integration of the KVM functionality into display monitors at marginal cost increase, when compared to non-KVM monitors. This cost increase is more than offset by the increased usability and marketability of KVM-monitors. For example, the various embodiments described herein provide solutions that address a user's need or desire to share devices in a multi-computer and/or multi-monitor configuration. They also enable multiple monitors to operate in a synchronized manner by sharing status information and optionally other display parameters (brightness, contrast, color balance, etc.), power settings (on-off), etc., while providing the user with a much simpler interface and ergonomic overhead. Synchronization between the multiple monitors may include, for instance, changing the brightness on one monitor causes the brightness in another monitor to change to an identical setting. As another example, the synchronization may be defined to include that a change on one monitor causes the same relative change to occur in another monitor. Linking multiple devices to form a desktop ensemble of input/output devices also allows a single user action (e.g., key-press sequence or button press) to perform simultaneous keyboard, mouse and display switchover between multiple source machines.

While the description presented above has focused on USB and DVI connections, it should be apparent that the same techniques would apply in configurations where video and peripheral signals are combined in a single connector or cable. In addition, although particular attention has been given to switching two-dimensional video outputs for visual monitors, exactly the same descriptions presented above would apply for audio, tactile, or 3D output devices.

What has been described and illustrated herein is an embodiment along with some of its variations. The terms, descriptions and figures used herein are set forth by way of illustration only and are not meant as limitations. Those skilled in the art will recognize that many variations are possible within the spirit and scope of the subject matter, which is intended to be defined by the following claims—and their equivalents—in which all terms are meant in their broadest reasonable sense unless otherwise indicated.

What is claimed is:

1. A display monitor for receiving connections from a plurality of processing devices, said processing devices being connectable to the display monitor to provide information that displays on the display monitor, the display monitor comprising:
a plurality of monitor inputs for connection to a first processing device and a second processing device;
a monitor switch for switching between the plurality of monitor inputs to selectively activate the plurality of monitor inputs;
a plurality of universal serial bus (USB) ports, wherein a first one of the USB ports is positioned at a first location on the display monitor and is dedicated to the first processing device, a second one of the USB ports is positioned at a second location on the display monitor and is dedicated to the second processing device, and a third one of the USB ports is positioned at a third location of the display monitor and is dedicated to either the first processing device or the second processing device; and
a USB switch for switching between the plurality of USB ports to selectively activate the plurality of USB ports,
wherein the monitor switch is internally linked to the USB switch to cause the monitor switch and the USB switch to switch concurrently with each other.

2. The display monitor according to claim 1, wherein the display monitor further comprises at least one output USB port that remains active regardless of which of the plurality of USB ports is active.

3. The display monitor according to claim 1, wherein the display monitor comprises a USB hub configured with automatic power control over the plurality of USB ports and wherein the USB hub is further configured to enable override of the automatic power control to cause at least one of the plurality of USB ports to remain powered regardless of the USB switch position.

4. The display monitor according to claim 1, wherein the display monitor further comprises a plurality of labels that distinguish between functions of the plurality of USB ports.

5. A monitor-sharing system comprising:
a first display monitor including multiple connection ports for connecting to a plurality of processing devices and at least one input device, wherein the first display monitor is configured to provide the at least one input device with selective access to the plurality of processing devices, wherein the selective access is configured to automatically switch connections between the at least one input device and the plurality of processing devices via the first display monitor;
a second display monitor including a plurality of monitor inputs for selective connection to the plurality of processing devices and the at least one input device, wherein the first display monitor facilitates the selective connection to the plurality of processing devices and the at least one input device; and
a communication channel between the first display monitor and the second display monitor, wherein the communication channel is configured to enable synchronized switching of the first display monitor and the second display monitor between the plurality of processing devices and the at least one input device.

6. The monitor-sharing system according to claim 5, wherein the multiple connection ports on the first display monitor and the second display monitor comprise universal serial bus (USB) ports, and wherein the communication channel is formed through communication made through the respective USB ports.

7. The monitor-sharing system according to claim 6, wherein the USB ports in the first display monitor and the second display monitor form a hierarchical tree architecture, wherein at least one USB port on the first display monitor comprises and at least one USB port on the second display comprise leaf nodes of the hierarchical tree architecture, wherein the leaf node of the at least one USB port on the first display monitor is at a higher level than the leaf node of the at least one USB port on the second display monitor, and wherein at least one input device is configured to be connected to the leaf node of at least one of the first display monitor and the second display monitor.

8. The monitor-sharing system according to claim 7, wherein each of a first processing device and a second processing device comprise USB master control in the hierarchical tree architecture, wherein each of the first processing device and the second processing device are wired to both the first display monitor and the second display monitor, and wherein the communication channel between the first display monitor and the second display monitor is formed through the wired connection of both of the first processing device and the second processing device to the first display monitor and the second display monitor.

9. The monitor-sharing system according to claim 7, wherein at least one of the first display monitor and the second display monitor is equipped with a USB master microcontroller programmed to facilitate downstream communication of commands along the hierarchical tree architecture of USB ports.

10. The monitor-sharing system according to claim 7, wherein at least one of the first display monitor and the second display monitor includes software stored on a computer-readable medium for embedded USB device functionality.

11. The monitor-sharing system according to claim 5, wherein the first display monitor and the second display monitor include dedicated link interfaces for enabling the communication channel to be created through dedicated communication links between the first display monitor and the second display monitor, and wherein the dedicated communication links comprise at least one of a wired and a wireless communication channel.

12. The monitor-sharing system according to claim 11, wherein the wireless communication channel between the first display monitor and the second display monitor comprises a dedicated wireless communication link.

13. The monitor-sharing system according to claim 11, wherein the wireless communication channel between the first display monitor and the second display monitor comprises a communication channel of a wireless local network and wherein the at least one input device is configured to communicate with at least one of the first display monitor and the second display monitor over the wireless local network.

14. The monitor-sharing system according to claim 11, wherein the dedicated link interfaces are positioned around edges of the first display monitor and the second display monitor and wherein the dedicated link interfaces are configured to enable discovery of relative locations of the plurality of display monitors with respect to each other.

15. The monitor-sharing system according to claim 5, wherein the communication channel is configured to enable synchronization of display parameters and power settings between the first display monitor and the second display monitor.
